(19) United States
(12) Patent Application Publication
(10) Pub. No.: US 2002/0116261 A1
(43) Pub. Date: Aug. 22, 2002

(54) Systems and methods that facilitate an exchange of supplemental information in association with a dispensing of fuel

(76) Inventors: Paul A. Moskowitz, Yorktown Heights, NY (US); Edith H. Stern, Yorktown Heights, NY (US); Barry E. Willner, Briarcliff Manor, NY (US); David P. Greene, Ossining, NY (US); Philip S. Yu, chappaqua, NY (US); Stephen J. Boies, Mahopac, NY (US); William Grey, Millwood, NY (US); Clifford A. Pickover, Yorktown Heights, NY (US); Samuel Dinkin, Austin, TX (US)

Correspondence Address: BUCKLEY, MASCHOFF, TALWALKAR, & ALLISON, 5 ELM STREET, NEW CANAAN, CT, 06840, US

(21) Appl. No.: 09/788,697

(22) Filed: Feb. 20, 2001

(51) Int. Cl. G06F 17/60

(52) U.S. Cl. 705/14; 705/40; 705/1; 700/231; 700/283

(57) ABSTRACT

Systems and methods are provided to facilitate an exchange of supplemental information in association with a dispensing of fuel. For example, a gasoline dispensing device may receive from a customer device a request for supplemental information, such as a request to receive an audio file or an updated emissions control software program. Supplemental information may then be transmitted to the customer device while gasoline is being dispensed to an automobile. According to one embodiment, the customer provides payment in exchange for the supplemental information.

### FIELD

The present invention relates to fuel dispensing systems. In particular, the present invention relates to systems and methods that facilitate an exchange of supplemental information in association with a dispensing of fuel.

### BACKGROUND

As various technologies associated with the use of information improve, people increasing want to exchange information. For example, a person may want to receive entertainment information (e.g., an electronic representation of a book, a song, a movie, and/or a video game). Similarly, a person may want to receive other types of information, such as mapping information associated with local roads and businesses. In addition to receiving information, a person may want to transmit information, such as an electronic mail message. Frequently, a person will want to receive and transmit these (and other) types of information while he or she travels.

Similarly, devices increasingly need to exchange information. For example, an automobile may use a number of software programs, such as an emissions control software program, or “driver,” that reduces an amount of pollution generated by the automobile. In this case, the automobile may need to receive an updated version of a software program when it becomes available. As another example, the automobile may need to transmit information to another device, such as information indicating that a particular maintenance operation should be performed (e.g., indicating that the oil should be changed).

Traditional methods of exchanging information, however, have a number of disadvantages. For example, a person may use his or her Personal Computer (PC) to access a Web site to receive information, such as a mapping information. The person can then transfer the mapping information from his or her PC to a data cartridge containing a Random Access Memory (RAM) unit. Finally, the person inserts the data cartridge into a mapping device mounted in his or automobile, such as a Global Positioning System (GPS) mapping device. Obviously, such an approach will be cumbersome if the mapping information needs to be frequently updated as he or she travels across long distances. Moreover, not everyone has a PC and/or the ability to access Web sites.

As another approach, the automobile may be equipped with a communication device that can directly receive information at any time. For example, an automobile may be equipped with an antenna that lets the automobile receive information from a satellite or cellular network while the automobile is being driven. Such communication devices, however, are expensive and may not operate under certain conditions (e.g., during poor weather conditions or when the automobile is outside a certain area of coverage).

Moreover, known methods of exchanging information may be inconvenient. For example, it may take several minutes to download a music video file to an entertainment device (depending on an available bandwidth and a desired image quality). It can be expected that many people will not want to spend time simply waiting for information to be exchanged.

### SUMMARY

To alleviate problems inherent in the prior art, the present invention introduces systems and methods that facilitate an exchange of supplemental information in association with a dispensing of fuel.

According to one embodiment of the present invention, it is arranged for supplemental information to be exchanged with a customer device in association with a dispensing of fuel. Information associated with the exchange of supplemental information may also be received.

Another embodiment is directed to a computer-implemented method of facilitating an exchange of supplemental information via a gasoline dispensing device. According to this embodiment, a request for supplemental information is received from a customer device. The request may include, for example, a supplemental information identifier. Supplemental information is then transmitted to the customer device while gasoline is being dispensed to a customer automobile, and it is arranged for a customer to provide payment in exchange for the supplemental information.

According to still another embodiment, information associated with an exchange of supplemental information is received at an information device. The information may be received, for example, from one of a plurality of remotes device associated with a dispensing of fuel. Supplemental information may also be exchanged with the remote device.

One embodiment of the present invention comprises: a communication device adapted to exchange supplemental information with a customer device; a fuel dispenser; and a controller adapted to facilitate an exchange of supplemental information and a dispensing of fuel.

Another embodiment comprises: means for receiving information associated with an exchange of supplemental information; and means for arranging for supplemental information to be exchanged with a customer device in association with a dispensing of fuel.

Another embodiment comprises: means for receiving from a customer device a request for supplemental information, the request including a supplemental information identifier; means for transmitting supplemental information to the customer device while gasoline is being dispensed to a customer automobile; and means for arranging for a customer to provide payment in exchange for the supplemental information.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a fuel dispensing system according to an embodiment of the present invention.

FIG. 2 is a block diagram overview of a fuel dispensing system according to another embodiment of the present invention.

FIG. 3 is a block diagram of a customer device according to an embodiment of the present invention.

FIG. 4 is a block diagram of a controller according to an embodiment of the present invention.

FIG. 5 is a tabular representation of a portion of a supplemental information database according to an embodiment of the present invention.

FIG. 6 is a tabular representation of a record in a transaction database according to an embodiment of the present invention.

FIG. 7 is a flow chart of a method according to an embodiment of the present invention.

FIGS. 8 and 9 illustrate customer devices displaying information according to some embodiments of the present invention.

### DETAILED DESCRIPTION

Embodiments of the present invention are directed to systems and methods that facilitate an exchange of supplemental information in association with a dispensing of “fuel.” As used herein, the term “fuel” refers to any substance that may be used to power a device. Examples of fuels include gasoline, propane, and electricity used to power a vehicle (such an automobile).

Moreover, “supplemental” information refers to any electronic information not directly associated with a purchase of fuel. Examples of supplemental information include electronic representations of text information, audio information, image information, entertainment information, and database information (e.g., mapping information). The supplemental information may also comprise, for example, executable information such as a software program adapted to be executed by an Electronic Control Unit (ECU) associated with the operation of an automobile.

Note that the “exchange” of supplemental information may comprise, for example, a fuel dispensing device transmitting supplemental information to a customer device. As another example, the exchange may comprise a customer device transmitting supplemental information to a fuel dispensing device.

Fuel Dispensing System Overview

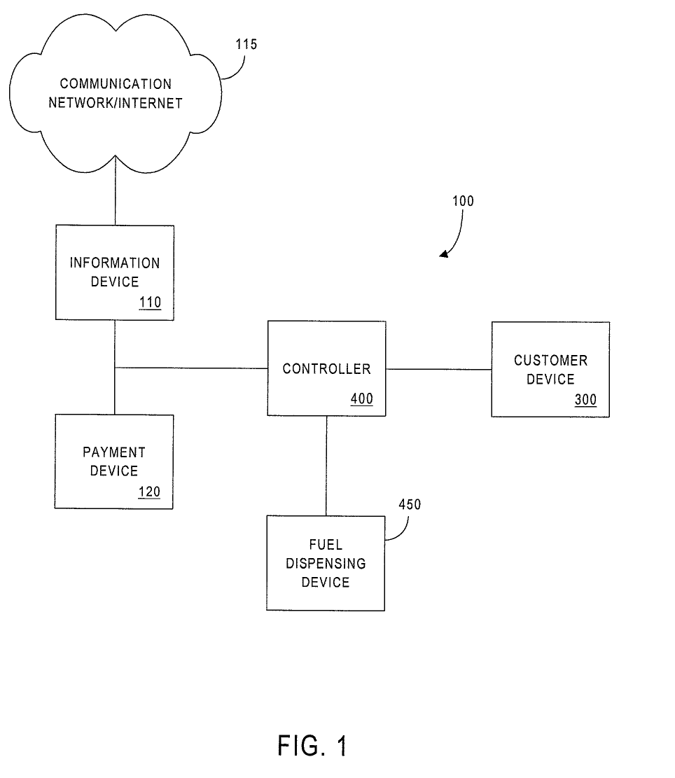

Turning now in detail to the drawings, FIG. 1 is a block diagram of a fuel dispensing system 100 according to one embodiment of the present invention. The fuel dispensing system 100 includes a controller 400 in communication with a customer device 300. As used herein, devices (such as the customer device 300 and the controller 400) may communicate via a direct connection, such as a Universal Serial Bus (USB) connection. Devices may also communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet.

Note that, as used herein, communications include those enabled by wired or wireless technology. For example, the controller 400 may communicate with the customer device 300 using Bluetooth technology. Bluetooth technology allows a wide range of computing and telecommunication devices to be interconnected via wireless connections. Specifications and other information regarding Bluetooth technology are available at the Bluetooth Web site www.bluetooth.com. In embodiments utilizing Bluetooth technology, communicating devices may be equipped with a microchip transceiver that transmits and receives information in a frequency band of 2.45 GHz (with some variation of bandwidth in different countries). Connections can be point-to-point or multipoint over a current maximum range of ten meters. Embodiments using Bluetooth technology may require the additional use of one or more communication stations (e.g., a communication station may be positioned near a fuel dispensing device, and the communication station may relay information between the controller 400 and the customer device 300).

Note that although a single controller 400 is shown in FIG. 1, any number of controllers 400 may be included in the fuel dispensing system 100. Similarly, any number of customer devices 300, or other devices described herein, may be included in the fuel dispensing system 100 according to embodiments of the present invention.

The customer device 300 and the controller 400 may be any devices capable of performing the various functions described herein. The customer device 300 may be, for example: a PC, a portable computing device such as a Personal Digital Assistant (PDA), a wired or wireless telephone, a game terminal (e.g., a SONY PLAY STATION(® video game terminal), an automobile or a processor associated with an automobile, or any other appropriate storage and/or communication device.

The controller 400 is also in communication with a fuel dispensing device 450. According to one embodiment, the controller 400 and the fuel dispensing device 450 are incorporated into a single device, such as a gasoline pump. According to one embodiment, the controller 400 also communicates with an information device 110. For example, controllers 400 located at a number of different gasoline stations may receive supplemental information (e.g., updated emissions control drivers) from one or more remote information devices 110.

The information device 110 may comprise, for example, a computing device including one or more storage devices adapted to store electronic information, such as MP3 files, image files (e.g., mapping information), or other digital information. According to one embodiment, the information device 110 receives such information and/or transmits such information to the controller 400 via a communication network 115, such as the Internet.

Note that the devices shown in FIG. 1 need not be in constant communication. For example, the controller 400 may communicate with the information device 110 on an as-needed or periodic basis. Similarly, the controller 400 may communicate with a customer device 300 only when the customer device 300 is located near the controller 400 or the fuel dispensing device 450.

According an embodiment of the present invention, the controller 400 receives information associated with an exchange of supplemental information. For example, the controller 400 may receive a request for supplemental information from the customer device 300 (e.g., from the customer's PDA). The request may include, for example, a customer identifier, a customer device identifier, a vehicle identifier, a supplemental information identifier, and/or a payment identifier. For example, the request may indicate that the customer would like to download a particular episode of a children's television show to a device associated with his or her automobile. Note that, according to one embodiment, the customer device 300 does not need to send a request for the supplemental information to the controller 400.

The controller 400 may then arrange for supplemental information to be exchanged with the customer device 300. For example, the controller 400 and/or the fuel dispensing device 450 may transmit the supplemental information to the customer device 300.

The supplemental information may comprise text information, such as a message stating that “The warranty associated with your tires is about to expire, would you like to pay $20.00 to extend the warranty for an additional year?” Similarly, the supplemental information may be a message from a trucking company to one (or all) of its employees. Other types of supplemental information include, for example, automobile recall information, Web pages, image information, audio information, database information (e.g., a list of local restaurant names and telephone numbers), executable information, entertainment information, map information, and/or advertisement information.

According to one embodiment, the supplemental information comprises executable information adapted to be executed by a processor in association with the operation of a vehicle. For example, the controller 400 may download one or more parameters, such as a fuel type, a location's altitude and ambient temperate, or an indication of the presence of Methyl Tertiary Butyl Ethane (MTBE) to let the automobile use the dispensed fuel more efficiently. The controller 400 may similarly transmit a software program to the customer's automobile that let the automobile use the dispensed fuel more efficiently.

Note that the controller 400 may receive the supplemental information from an information device 110 before transmitting it to the customer device 300. For example, a radio in a customer's automobile may include a “Purchase This Song” button that can be activated when the customer hears a song that he or she enjoys. The next time the customer visits a gasoline station, the radio may automatically send a request for that song to the controller 400. In this case, the controller 400 may retrieve the appropriate information from the information device 110 (e.g., by downloading an MP3 file from a Web site) before the supplemental information is transmitted to the radio.

According to one embodiment, information received from the customer device 300 is used to select the supplemental information that will be exchanged. For example, a Vehicle Identification Number (VIN) received from the customer's automobile may be used to determine one or more software program updates that will be transmitted to the customer's automobile. According to another embodiment, the controller 400 selects the supplemental information based on customer preference information. For example, the controller 400 may automatically transmit sports information associated with the customer's favorite teams.

Instead of, or in addition to, transmitting supplemental information to the customer device 300, the controller 400 may receive supplemental information from the customer device 300. For example, the customer device 300 may transmit a vehicle parameter (e.g., an engine temperature) or maintenance information (e.g., an indication that the oil was last changed six months ago) to the controller 400. In this case, the fuel dispensing system 150 may, for example, instruct a gasoline station attendant to ask the customer if he or she would like the oil changed. As another example, electronic mail messages generated by a customer may be transmitted from the customer device 300 to the controller 400 (e.g., to be forwarded by the controller 400 as appropriate).

According to one embodiment, the controller 400 arranges for a customer to provide payment in exchange for supplemental information. For example, the controller 400 may communicate with the payment device 120 to arrange for the customer to provide payment (e.g., via his or her credit card account, debit card account, banking account, or a digital payment protocol) based on an exchange of supplemental information and an amount of dispensed fuel. The payment device 120 may comprise, for example, a credit card processing device such as those manufactured by GILBARCO® or VERIFONE®. The payment device 120 may also comprise a remote device associated with a third party, such as a credit card approval and processing device.

According to another embodiment, the controller 400 instead arranges to provide payment to a customer based on the exchange of supplemental information (e.g., by paying the customer $0.25 for maintenance information associated with his or her automobile). Note that payments may also be exchanged with a third party (e.g., an entertainment company associated with the information device 110). Also note that the customer device 300 may communicate directly with the payment device 120.

Instead of receiving or providing payments based on the exchange of supplemental information, the controller 400 may adjust a price associated with either the supplemental information or an amount of dispensed fuel. For example, the controller 400 may arrange for a customer to pay (i) $3.00 for an MP3 file if he she purchases less than ten gallons of gasoline or (ii) $1.00 for the MP3 file if he she purchases at least ten gallons of gasoline.

According to one embodiment, the controller 400 and/or the fuel dispensing device 450 also arrange for fuel to be dispensed to an automobile. Note that the supplemental information may be exchanged with the customer device 300 while the fuel is being dispensed, thus reducing the inconvenience to the customer (e.g., he or she can save time by receiving supplemental information and fuel at substantially the same time).

Moreover, the controller 400 may exchange supplemental information with a plurality of customer devices 300 (associated with a single customer or a plurality of customers) at substantially the same time.

Examples

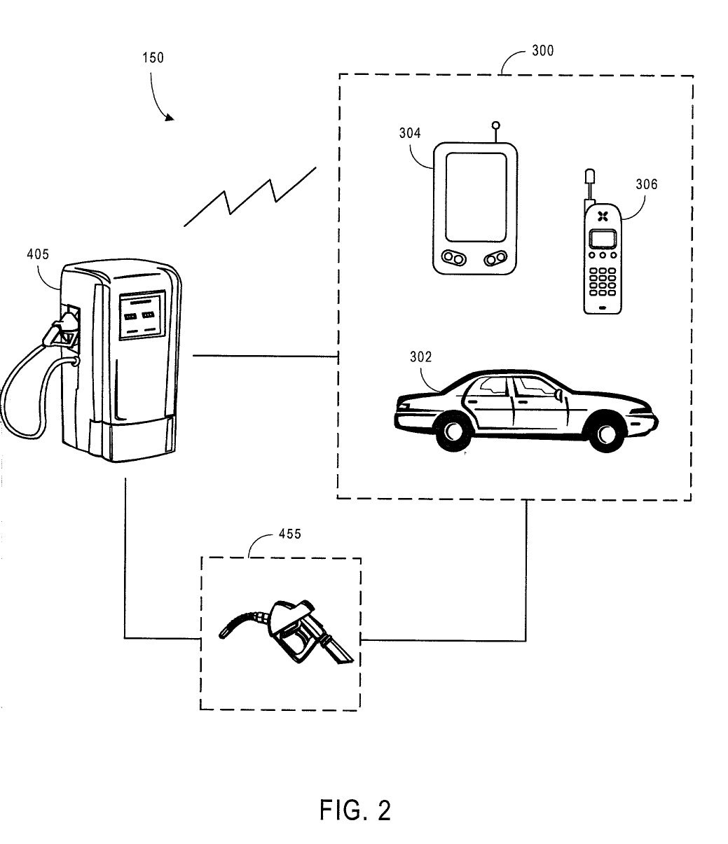

Several examples will now be described with respect to FIG. 2, which is a block diagram overview of a fuel dispensing system 150 according to another embodiment of the present invention. As shown in FIG. 2, a fuel pump 405 (which includes, or communicates with, the controller 400 described with respect to FIG. 1) and/or a fuel nozzle 455 may communicate with an automobile 302, a wireless (e.g., Bluetooth) equipped PDA 304, and/or a wireless telephone 306.

When a customer drives his or her automobile 302 near the fuel pump 405, the automobile 302 transmits a request for supplemental information including (i) the automobile's manufacturer, model number, VIN, and year of manufacture and (ii) a list of software program versions currently being used by the automobile 302. Based on this information, the fuel pump 405 determines that a new fuel injection software program is available and transmits the program to the automobile 302 via a wireless communication. According to another embodiment, the information is instead transmitted via the fuel nozzle 455 by direct physical electrical contact with the automobile 302.

The customer begins to fuel the automobile and requests that a music video be transmitted to his or her PDA 304. The fuel pump 405 then transmits this information as the fuel is being dispensed. In addition, the customer's wireless telephone 306 automatically requests and receives a list of names and telephone numbers associated with local businesses.

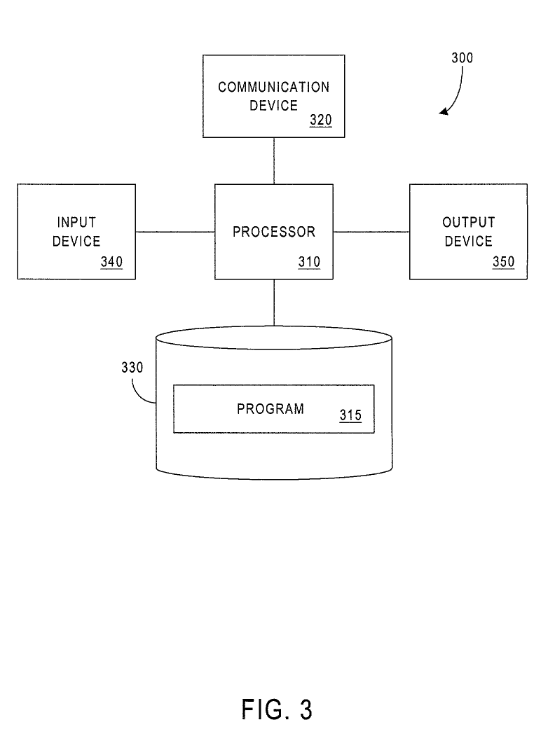

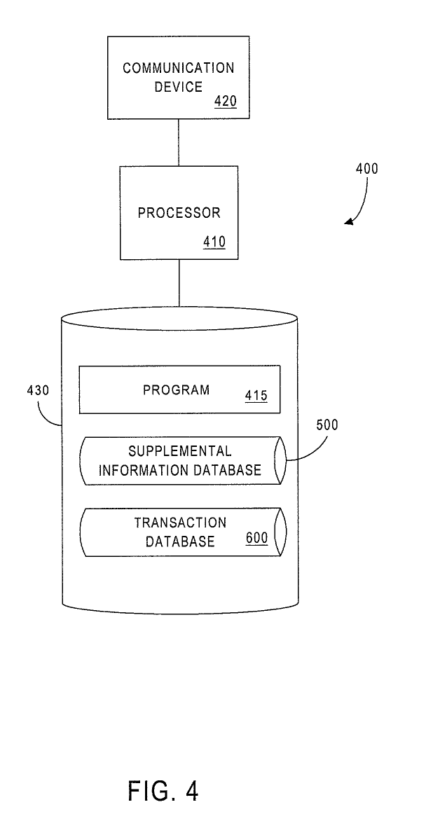

Examples of devices that may be used in connection with the fuel dispensing systems 100, 150 will now be described in detail with respect to FIGS. 3 and 4.

Customer Device

FIG. 3 illustrates a customer device 300 that is descriptive of the device shown in FIG. 1 according to an embodiment of the present invention. The customer device 300 comprises a processor 310, such as one or more INTEL® Pentium® processors, coupled to a communication device 320 configured to communicate via a communication network (not shown in FIG. 3). The communication device 320 may be used to communicate, for example, with one or more controllers 400 and/or payment devices 120.

The processor 310 is also in communication with an input device 340. The input device 340 may comprise, for example, a keyboard, a mouse or other pointing device, a microphone, a knob or a switch (including an electronic representation of a knob or a switch), an infrared port, a docking station, and/or a touch screen. Such an input device 340 may be used, for example, by a customer to generate or request supplemental information.

The processor 310 is also in communication with an output device 350. The output device 350 may comprise, for example, a display (e.g., a computer monitor), a speaker, and/or a printer. The output device 350 may be used, for example, to provide supplemental information to a customer.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as RAM devices and Read Only Memory (ROM) devices.

The storage device 330 stores a program 315 for controlling the processor 310. The processor 310 performs instructions of the program 315, and thereby operates in accordance with the present invention. For example, the processor 310 may arrange for a customer to receive and/or transmit supplemental information.

As used herein, information may be “received” by or “transmitted” to, for example: (i) the customer device 300 from the controller 400; or (ii) a software application or module within the customer device 300 from another software application, module, or any other source.

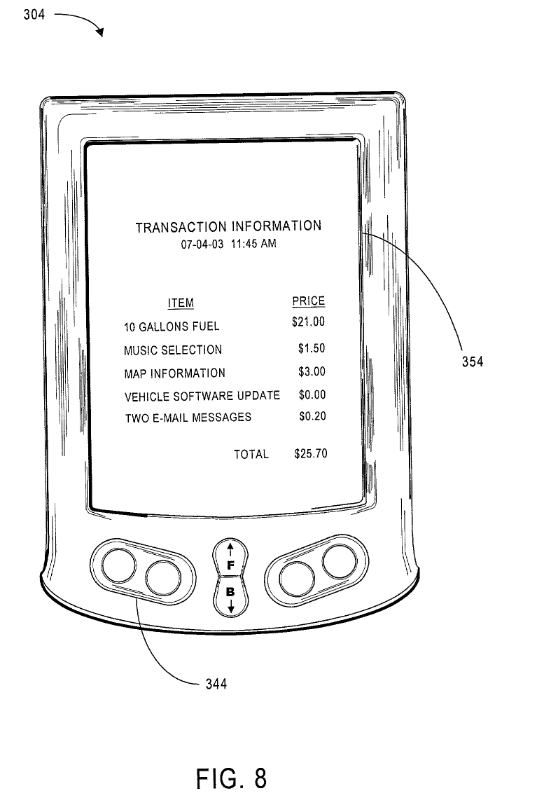

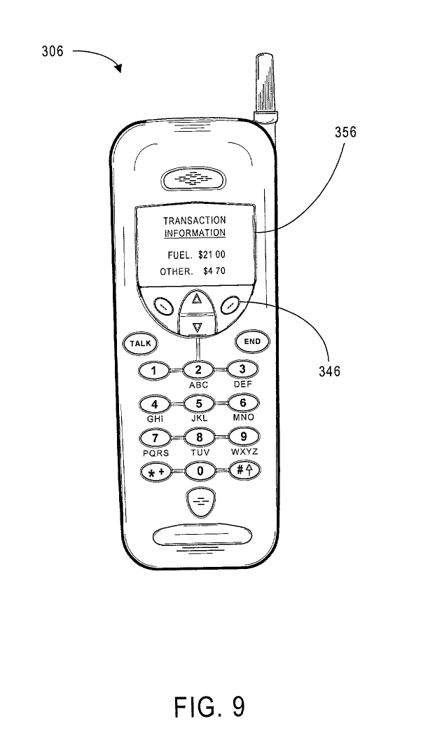

FIG. 8 illustrates a customer PDA 304 displaying transaction information according to an embodiment of the present invention. As shown in FIG. 8, the customer has received a music selection, map information, and an update to his or her automobile's software in addition to an amount of dispensed fuel. The customer PDA 304 includes an input device 344 and an output device 354 (e.g., a display screen) that may be used by a customer to request and receive supplemental information. Similarly, FIG. 9 illustrates a wireless telephone 306 including an input device 346 and an output device 356 displaying transaction information.

Controller

FIG. 4 illustrates a controller 400 that is descriptive of the device shown in FIG. 1 according to an embodiment of the present invention. The controller 400 comprises a processor 410, such as one or more INTEL® Pentium® processors, coupled to a communication device 420 configured to communicate via a communication network (not shown in FIG. 4). The communication device 420 may be used to communicate, for example, with one or more customer devices 300, fuel dispensing devices 450, information devices 110, and/or payment devices 120.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as RAM devices and ROM devices.

The storage device 430 stores a program 415 for controlling the processor 410. The processor 410 performs instructions of the program 415, and thereby operates in accordance with the present invention. For example, the processor 410 may receive information associated with the exchange of supplemental information and arrange for supplemental information to be exchanged with a customer device 300 in association with a dispensing of fuel.

According to another embodiment, the processor 410 receives from a customer device 300 a request for supplemental information, the request including a supplemental information identifier. The processor 410 may then transmit supplemental information to the customer device 300 while gasoline is being dispensed to a customer automobile 302. Moreover, the processor 410 may arrange for a customer to provide payment in exchange for the supplemental information.

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the controller 400 from the customer device 300; or (ii) a software application or module within the controller 400 from another software application, module, or any other source.

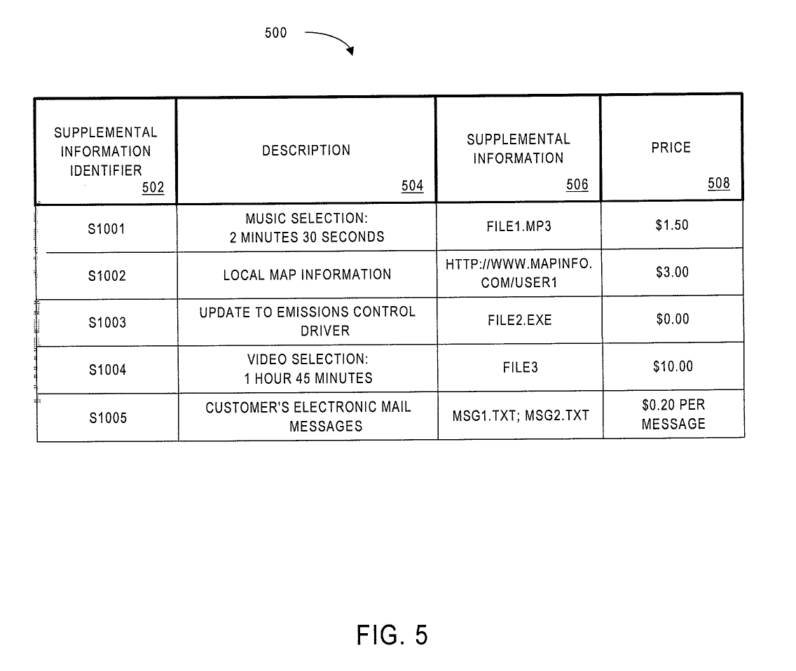

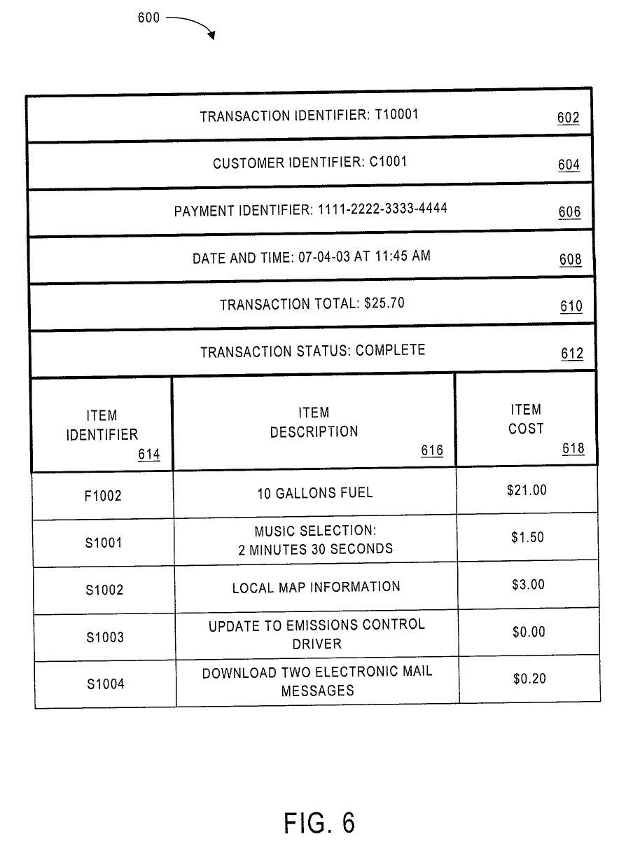

As shown in FIG. 4, the storage device 430 also stores a supplemental information database 500 (described with respect to FIG. 5) and a transaction database (described with respect to FIG. 6). Examples of databases that may be used in connection with the fuel dispensing systems 100, 150 will now be described in detail with respect to FIGS. 5 and 6. The illustrations and accompanying descriptions of the databases presented herein are exemplary, and any number of other database arrangements could be employed besides those suggested by the figures.

Supplemental Information Database

Referring to FIG. 5, a table represents the supplemental information database 500 that may be stored at the controller 400 according to an embodiment of the present invention. The table includes entries identifying supplemental information that can be exchanged via the fuel dispensing system 100. The table also defines fields 502, 504, 506, 508 for each of the entries. The fields specify: a supplemental information identifier 502, a description 504, supplemental information 506, and a price 508. The information in the supplemental information database 500 may be created and updated, for example, based on information received from one or more information devices 110.

The supplemental information identifier 502 may be, for example, an alphanumeric code associated with supplemental that can be exchanged via the fuel dispensing system 100. The supplemental information identifier 502 may be generated by, for example, the controller 400 or an information device 110.

The description 504 may contain, for example, text, audio, and/or image information that describes the supplemental information. According to one embodiment, the description 504 is provided to a customer (e.g., via the fuel pump 405).

The supplemental information 506 may comprise information that can be exchanged with a customer device 300, or may comprise a pointer to the information (e.g., enabling the information to be retrieved via a Web site). The price 508 indicates an amount that a customer must pay in exchange for the supplemental information.

According to another embodiment, the supplemental information database 500, or another database, also stores information that may be received from a customer device (e.g., electronic mail messages generated by the customer).

Transaction Database

Referring to FIG. 6, a table represents a record in the transaction database 600 that may be stored at the controller 400 according to an embodiment of the present invention. The database includes records associated with transactions associated with the fuel dispensing system 100. The information in the transaction database 600 may be created and updated, for example, when a customer purchases fuel and/or supplemental information via the fuel dispensing system 100.

As shown in FIG. 6, each record indicates a transaction identifier 602 and a customer identifier 604 associated with the transaction and a customer, respectively. Each record also includes a payment identifier 606 associated with the transaction. The payment identifier 606 may comprise, for example, a credit card, debit card or bank account number (e.g., a checking account number) or digital payment protocol information. The payment identifier 606 may be used, for example, by the controller 400 to arrange for the customer to provide or receive payment. A date and time 608 indicates a date and time associated with the transaction, and a transaction total 610 indicates a total amount paid by the customer (e.g., in exchange for fuel and supplemental information). A transaction status 612 indicates whether the transaction is “in process” or “complete.”

The table also defines fields 614, 616, 618 for each record. The fields specify: an item identifier 612, an item description 616, and an item cost 618.

The item identifier 614 indicates an item that was purchased by the customer. In the case of a supplemental information item, the item identifier 614 may be based on, or associated with, the supplemental information identifier 502 stored in the supplemental information database 500. The item description 616 describes the item purchased by the customer. In the case of a supplemental information item, the item description 616 may be based on, or associated with, the description 504 stored in the supplemental information database 500.

The item cost 618 indicates an amount paid by the customer in exchange for the item. In the case of a supplemental information item, the item cost 618 may be based on, or associated with, the price 508 stored in the supplemental information database 500. Note that the transaction total 610 may be calculated by adding each item cost 618 associated with the transaction.

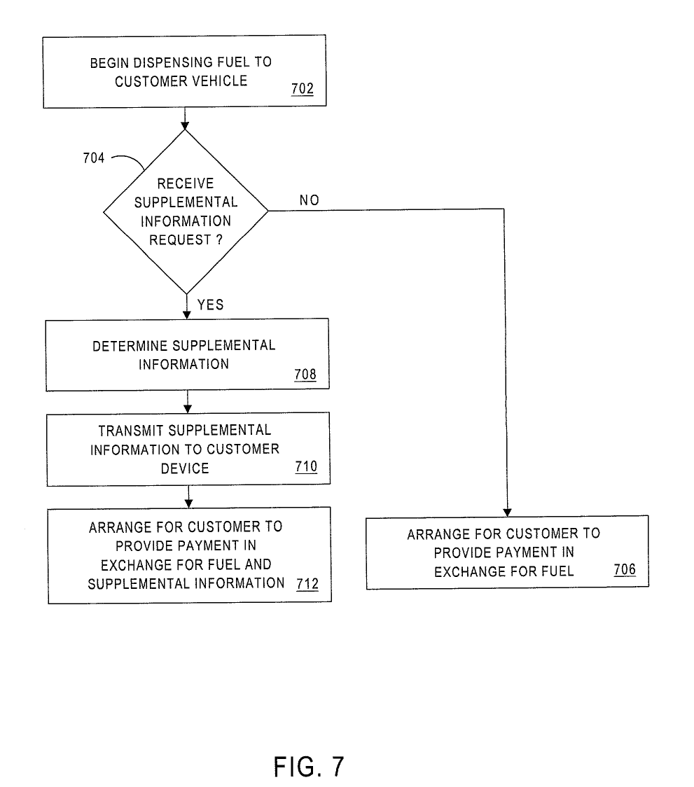

A method that may be used in connection with the fuel dispensing systems 100, 150 according to an embodiment of the present invention will now be described in detail with respect to FIG. 7.

Fuel Dispensing System Methods

FIG. 7 is a flow chart of a computer-implemented method of facilitating an exchange of supplemental information. The method may be performed, for example, by a controller 400 that communicates with a customer device 300. The flow chart in FIG. 7 does not imply a fixed order to the steps, and embodiments of the present invention can be practiced in any order that is practicable. Moreover, the method may instead be performed by any of the other devices described herein, including a customer device 300.

At 702, the controller 400 and/or the fuel dispensing device 450 begin dispensing fuel to a customer's vehicle. If no supplemental information request is received at 704, it is arranged for the customer to provide payment in exchange for the dispensed fuel at 706.

If, however, a supplemental information request is received at 704, the controller 400 determines the supplemental information at 708 (e.g., based on information in the request). At 710, the supplemental information is transmitted to a customer device 300 and it is arranged for the customer to provide payment in exchange for the dispensed fuel and the supplemental information at 712.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated fuel being dispensed to an automobile, according to another embodiment supplemental information is exchanged in association with fuel being dispensed to an airplane or a boat. In this case, the supplemental information may comprise, for example, routing information, weather information, maintenance information, and/or schedule information. Similarly, according to other embodiments, fuel is instead dispensed from a fuel delivery service to a gasoline station or from an oil delivery service to a customer's home oil tank. In this case, the supplemental information may, for example, indicate a type or a quantity of fuel being provided.

According to another embodiment, the supplemental information can prevent fuel from being dispensed. For example, a customer's automobile may transmit governmental inspection and emissions information to a fuel pump. The fuel pump may then use that information to determine if fuel will be dispensed to the automobile.

According to still another embodiment, the controller 400 determines if a customer is authorized to receive supplemental information. For example, a customer may be required to pay a monthly subscription fee in order to be authorized to receive supplemental information.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating an exchange of supplemental information, comprising:
receiving information associated with the exchange of supplemental information; and
arranging for supplemental information to be exchanged with a customer device in association with a dispensing of fuel.

2. The method of claim 1, wherein said receiving comprises:
receiving a request for the supplemental information.

3. The method of claim 2, wherein the request for the supplemental information includes at least one of: (i) a customer identifier, (ii) a customer device identifier, (iii) a vehicle identifier, (iv) a supplemental information identifier, and (v) a payment identifier.

4. The method of claim 1, wherein the supplemental information is exchanged via at least one of: (i) a wireless device, (ii) a Bluetooth device, (iii) a communication port, (iv) a device associated with the dispensing of fuel, and (v) a fuel nozzle by direct physical electrical contact.

5. The method of claim 1, wherein the customer device comprises at least one of: (i) a portable computer, (ii) a personal digital assistant, (iii) a wireless telephone, (iv) an information providing device, (v) an entertainment device, (vi) a game device, and (vii) a vehicle device.

6. The method of claim 1, wherein said arranging comprises:
transmitting the supplemental information to the customer device.

7. The method of claim 6, wherein the supplemental information comprises at least one of: (i) text information, (ii) image information, (iii) audio information, (iv) database information, (v) executable information, (vi) entertainment information, (vii) map information, and (viii) advertisement information.

8. The method of claim 6, wherein the fuel is dispensed to a vehicle, and the supplemental information comprises executable information adapted to be executed by a processor in association with the operation of the vehicle.

9. The method of claim 6, wherein the supplemental information is associated with the dispensed fuel.

10. The method of claim 6, further comprising:
receiving the supplemental information from a remote information device before the supplemental information is transmitted to the customer device.

11. The method of claim 10, wherein said receiving the supplemental information is performed via the Internet.

12. The method of claim 6, further comprising:
determining the supplemental information based on customer preference information.

13. The method of claim 1, wherein said arranging comprises:
receiving the supplemental information from the customer device.

14. The method of claim 13, wherein the supplemental information comprises at least one electronic mail message generated by the customer.

15. The method of claim 13, wherein the fuel is dispensed to a vehicle, and the supplemental information is associated with the operation of the vehicle.

16. The method of claim 14, wherein the supplemental information comprises at least one of: (i) a vehicle parameter, (ii) maintenance information, (iii) fuel consumption information, and (iv) customer information.

17. The method of claim 1, further comprising:
arranging for a customer to provide payment in exchange for the supplemental information.

18. The method of claim 17, wherein the payment is provided via at least one of:
(i) a credit card account, (ii) a debit card account, (iii) a banking account, and (iv) a digital payment protocol.

19. The method of claim 17, wherein the payment is provided via a payment identifier, and the payment identifier is further used to arrange for the customer to provide payment in exchange for the dispensed fuel.

20. The method of claim 1, further comprising:
arranging to provide payment to a customer in exchange for the supplemental information.

21. The method of claim 1, further comprising:
adjusting a price associated with the dispensed fuel based on the exchange of the supplemental information.

22. The method of claim 1, further comprising:
adjusting a price associated with the supplemental information based on a purchase of the dispensed of fuel.

23. The method of claim 1, further comprising:
arranging for the fuel to be dispensed.

24. The method of claim 1, wherein the supplemental information is exchanged while the fuel is being dispensed.

25. The method of claim 1, wherein supplemental information is exchanged with a plurality of customer devices substantially simultaneously.

26. A computer-implemented method of facilitating an exchange of supplemental information via a gasoline dispensing device, comprising:
receiving from a customer device a request for supplemental information, the request including a supplemental information identifier;
transmitting supplemental information to the customer device while gasoline is being dispensed to a customer automobile; and
arranging for a customer to provide payment in exchange for the supplemental information.

27. An apparatus, comprising:
a processor; and
a storage device in communication with said processor and storing instructions adapted to be executed by said processor to:
receive information associated with an exchange of supplemental information; and
arrange for supplemental information to be exchanged with a customer device in association with a dispensing of fuel.

28. The apparatus of claim 27, wherein said storage device further stores at least one of: (i) a supplemental information database, and (ii) a transaction database.

29. The apparatus of claim 27, further comprising:
a communication device coupled to said processor and adapted to communicate with at least one of: (i) a remote information device, (ii) a customer device, (iii) a vehicle device, (iv) a fuel dispensing device, and (v) a payment device.

30. A medium storing instructions adapted to be executed by a processor to perform a method of facilitating an exchange of supplemental information, said method comprising:
receiving information associated with the exchange of supplemental information; and
arranging for supplemental information to be exchanged with a customer device in association with a dispensing of fuel.

31. A method of facilitating an exchange of supplemental information, comprising:
receiving, at an information device, information associated with an exchange of supplemental information, the information being received from one of a plurality of remotes device associated with a dispensing of fuel; and
exchanging supplemental information with the remote device.

32. A method of facilitating an exchange of supplemental information, comprising:
arranging for supplemental information to be exchanged with a customer device in association with a dispensing of fuel; and
arranging for a customer to provide payment in exchange for at least one of: (i) the supplemental information, and (ii) an amount of dispensed fuel.

33. A system for exchanging supplemental information and dispensing fuel, comprising:
a communication device adapted to exchange supplemental information with a customer device;
a fuel dispenser; and
a controller adapted to facilitate an exchange of supplemental information and a dispensing of fuel.
